(19) United States
(12) Patent Application Publication
(10) Pub. No.: US 2008/0076388 A1
(43) Pub. Date: Mar. 27, 2008

(54) Method and System for Processing a User's Identity

(76) Inventors: Alain Nochimowski, Paris (FR); Laurent Feurer, Caen (FR)

Correspondence Address: Cohen Pontani Lieberman & Pavane, 551 Fifth Avenue, Suite 1210, New York, NY, 10176, US

(21) Appl. No.: 11/632,694

(22) PCT Filed: Jul. 12, 2005
(86) PCT No.: PCT/FR05/01791

§ 371 Date: Jan. 16, 2007

(30) Foreign Application Priority Data
Jul. 15, 2004 (FR) 0407889

(51) Int. Cl. H04M 1/66

(52) U.S. Cl. 455/411

(57) ABSTRACT

System and method for processing the identity of a user of a first terminal (10) connected to a telecommunications network in order to access a communications service. The system comprises an identity processing server (11) configured to receive from said first terminal (10) an identity parameter of the user of said first terminal (10) and a parameter corresponding to said communications service (14, 14′, 14″, 14′″); a rule management module (20) in said identity processing server (11) configured to look up and process a rule stored in a database (12) connected to said rule management module; and a service platform (13, 13′) configured to receive from said identity processing server (11) said parameter processed as a function of said rule and, after consumption of said communications service (14, 14′, 14″, 14′″) by said first terminal (10), to generate a call report including said parameter corresponding to said communications service (14, 14′, 14″, 14′″) and said processed identity parameter.

The present invention relates to a method and a system for processing the identity of a user of a terminal connected to a telecommunications network in order to access a communications service.

The invention applies more particularly to entering an identity parameter in a call report after processing the identity of the user of a terminal.

The communications service may be of any kind, such as consuming telephone call minutes, sending an SMS (Short Messaging Service) message or an MMS (Multimedia Messaging Service) multimedia message, or any other communications service.

At present, at the time of access to a communications service, identifying the user by an identifier, generally one that is recognized by the telecommunications network, is enough to authorize access to said communications service. To access other communications services, users must identify and/or authenticate themselves, for reasons of security or confidentiality those are a function of the nature of the services. In all circumstances, for billing the consumption of a service, the service provider sends a call report including “service identification” and “user identity” parameters.

The call report contains information corresponding to the identity of the user consuming the service, for example, the MSISDN (Mobile Subscriber ISDN) identifier number in the case of a mobile terminal or an electronic mail (e-mail) address or any other identifier of the user subscribing to the service, etc. The identity of the user contained in the call report is generally the identity of the telephone line subscriber, which is recognized by the telecommunications network. The call report also contains the identification of the service consumed by the user. Once the call report has been sent to the billing service, it is used to reserve on the subscriber account corresponding to the user identifier an amount associated with the consumption of the service.

If the identity of the user is recognized by the network on the basis of a user identifier, the consumption of the communications service is billed to the user corresponding to the identifier. On reception of said call report, the existing billing service can invoice the consumption of said communications service to a predefined user in a fixed manner.

When the user has been identified and/or authenticated, in order to debit an account of a subscriber who does not correspond to the recognized “user identity”, it is necessary to identify and/or authenticate that user by means of the secret code (generally called the “login” name) and the password of an account other than the user's own account. This means that the real holder of the account must intentionally communicate his or her own secret code and password to the person actually using the service. This presents obvious confidentiality problems.

Moreover, if the user of the service is identified and/or authenticated by means of the secret code and password of another account, that user is not able to benefit from his or her own usual and specific user profile, for example a record of previous uses, personalization of the service corresponding to particular preferences, etc.

Thus the technical problem to be solved by the present invention is proposing a method and a system for processing the identity of a user of at least one terminal connected to a telecommunications network in order to access a telecommunications service that would eliminate the drawbacks of existing systems by dissociating the identity contained in the call report and that recognized by the telecommunications network.

The solution in accordance with the present invention to the stated technical problem consists in that said method comprises the steps of:
at least an identity processing server receiving at least an identity parameter of the user of said first terminal and a parameter corresponding to said communications service;
at least a rule management module in said identity processing server using said identity parameter to look up at least a rule stored in at least a database connected to said rule management module;
said rule management module processing said rule;
said identity processing server sending at least a service platform said identity parameter processed as a function of said rule; and
after consumption of said communications service by said first terminal, said service platform generating at least a call report including said parameter corresponding to said communications service and said processed identity parameter.

Likewise, according to the invention, a system for processing the identity of at least one user of a first terminal connected to a telecommunications network in order to access at least a communications service is noteworthy in that said system comprises:
at least an identity processing server configured to receive from said first terminal at least an identity parameter of the user of said first terminal and a parameter corresponding to said communications service;
at least a rule management module in said identity processing server configured to look up and process at least a rule stored in at least a database connected to said rule management module; and
at least a service platform configured to receive from said identity processing server said parameter processed as a function of said rule and, after consumption of said communications service by said first terminal, to generate at least a call report including said parameter corresponding to said communications service and said processed identity parameter.

A system according to the invention for processing the identity of a user of a terminal comprises at least one identity processing server and at least one service platform. One or more databases are connected to said identity processing server.

Said processing system and method manage the identity of a user of a first terminal connected to a telecommunications network. The user of the first terminal wishes to use a communications service. At the time of access to said service, the identity processing server receives the identifier of the user of said first terminal, who is to be recognized as the user of said communications service.

The technical result obtained by the system and the method according to the invention aims to process the identity of the user corresponding to the identity parameter sent to the identity processing server by the telecommunications network. After checking and processing it in accordance with one or more rules linked to said identity parameter, the identity of the user processed by the identity processing server is entered in a communications service call report.

The system and the method according to the invention are such that the identity of the user sent after processing by the identity processing server for inclusion in a communications service call report can be different from the identity recognized by the telecommunications network or the identity entered manually by the user and received at the time of access to said communications service. Said system and method for processing the identity of the user provide for modifying and choosing said identity parameter as part of the process of creating call reports.

Said identity parameter may be, for example, an electronic mail address or an identifier of a mobile terminal (such as the MSISDN identifier) or any other identifier of the user.

In this way, the same user can be managed with more than one identity on the basis of identity management rules. More precisely, more than one subscriber identifier may be associated with the same user identifier. Management of the identity of the user of the service is dynamic and varies as a function of said rules, in particular as a function of the service consumed, context, time of day, credit, etc. Said rules for using a service may be stored beforehand or during use of the service.

In fact, a user may have separate identities for accessing the same or different services, for example a first identity corresponding to a “private user” profile and a second identity corresponding to a “business user” profile. The preferences of the user and the functions or options available may be different for each identity, for example with separate charging arrangements.

When a service call report is sent by a service platform, the identity entered in said call report may then be dissociated from the identity of the user of said service. As a general rule, in the context of the use concerned of the service, a call report can be linked to any pertinent identity (group identity, private identity, head of household identity, business identity, etc.).

According to the invention, said identity processing server receives said identity and service parameters, separately or in combination, from said first terminal or from said service platform.

The identity processing server receives an identity parameter for the user of said first terminal and a parameter corresponding to said communications service.

Said identity and service parameters may come either from said first terminal, for example through recognition by the network or manual entry of the identifier by the user of the first terminal, or from the service platform 13, 13′. The user of the first terminal is then recognized from the identity parameter sent to the identity processing server.

According to the invention, before access by said first terminal to said communications service, said first terminal or the operator of the telecommunications network, separately or in combination, store in said database one or more rules for managing the identity of the user of said first terminal.

The first terminal may store a user identity management rule beforehand, prior to any access to a communications service, in order to manage the user's identity in a predefined way. For example, a rule may specify that to use the service X with an identifier of the user A, the identity to send is the identifier of the user B, such that (service X, identifier A)=identity B. However, storing a rule in memory beforehand is not essential for the system to function.

Independently of rules stored (or not) by the user, the telecommunications network operator can also store predefined rules for managing the identity of the user of a terminal in order to manage optimally the identity entered in a call report and consequently the billing for a communications service accessed by said user.

In accordance with the invention, said first terminal commands said identity processing server to receive said identity parameter of the user of said first terminal.

In accordance with the invention, said identity processing server is automatically commanded to receive said identity parameter of the user of said first terminal.

Said system can be configured directly by users or by the telecommunications network operator. According to the configuration, the identity processing server can be commanded only by said first terminal to receive the identity parameter of the user of the first terminal. According to the parameter settings effected by the operator or the by the user, said identity processing server may also be automatically and systematically commanded to receive said identity parameter of the user of the first terminal at the time of access to a communications service.

According to the invention, said first terminal stores in said database one or more rules for managing the identity of the user of said terminal applicable during access of said first terminal to said communications service.

Since storing a rule beforehand is optional, a rule may be stored by the first terminal at the time of using a communications service. During access by the first terminal to a communications service, it may store in said database a rule for managing the identity of the user of said first terminal, if it has not done so beforehand, or for managing it in a particular way different from the rules already stored, or for modifying an existing rule. Said rule is then applicable to the current management of the identity of the user during access by the first terminal to said communications service.

According to the invention, at the time of processing said rule, said rule management module establishes a connection with one or more second terminals for checking said identity parameter.

Depending on what is required, said rule management module may contact a second terminal at the time of processing the identity of the user of the communications service, to request an authorization. In fact, a rule may specify that on reception of a defined user identifier (said first terminal), another defined user (the second terminal) must be requested to authorize sending its identity instead of either that recognized by the telecommunications network or that entered manually by the user. This is the case, for example, for access to a service by a child, where one of the parents is requested to authorize sending the identity. This is also the case for a service for which the actual user indicates that consumption of the service is to be billed to a third party, in which case the communications service is billed to an identified third party after obtaining the agreement of said third party.

According to the invention, said processed identity parameter corresponds to the identity of a user who is independent of the first terminal or of said communications service.

Processing the identity in order to enter a processed identity parameter into a call report after consumption of a communications service defines the identity of a user for the purpose of billing the service consumed. The identity of the user may be completely independent of said first terminal or said communications service. This system and this method therefore generalize third party billing and enter an identity parameter corresponding to any subscriber, either predefined or entered manually by the user of the first terminal.

According to the invention, to authorize access by said first terminal to said communications service, said service platform checks the balance of at least a subscriber account corresponding to the identity sent by means of said processed identity parameter.

If necessary, on reception of said processed identity parameter, the service platform checks the balance of a subscriber account corresponding to the identity sent by means of said processed identity parameter, in order to authorize the first terminal to access said communications service. In the event of a positive result, in particular if the balance of said subscriber account shows sufficient credit, the communications service may then be used.

There is no check on the balance of a subscriber account in the case of access to a post-paid communications service, since the payment is effected independently of any subscriber account.

The following description with reference to the appended drawings, which are provided by way of non-limiting example, explains clearly in what the invention consists and how it may be put into practice.

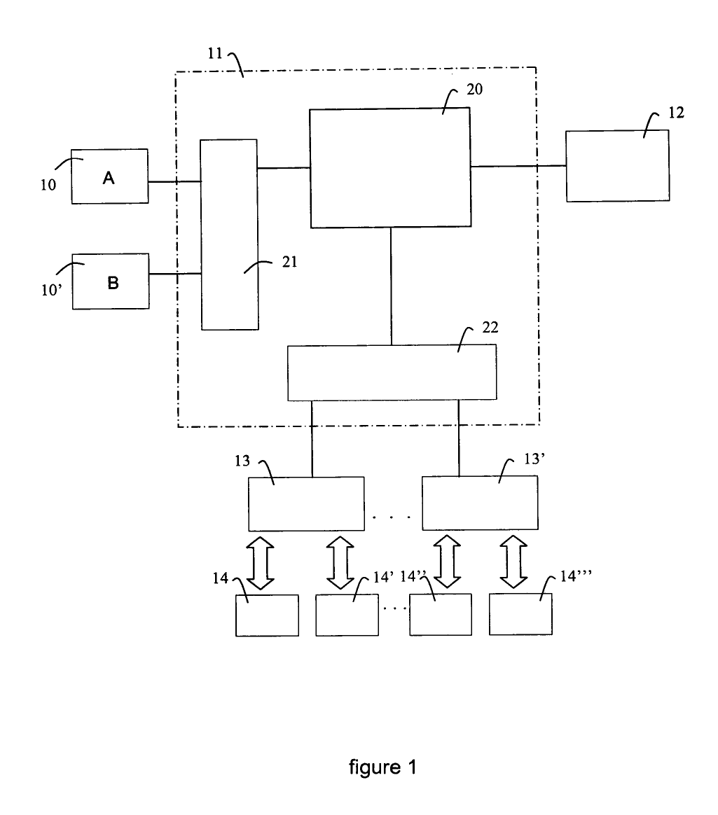

FIG. 1 represents the general architecture of a system in accordance with the invention for processing the identity of a terminal user.

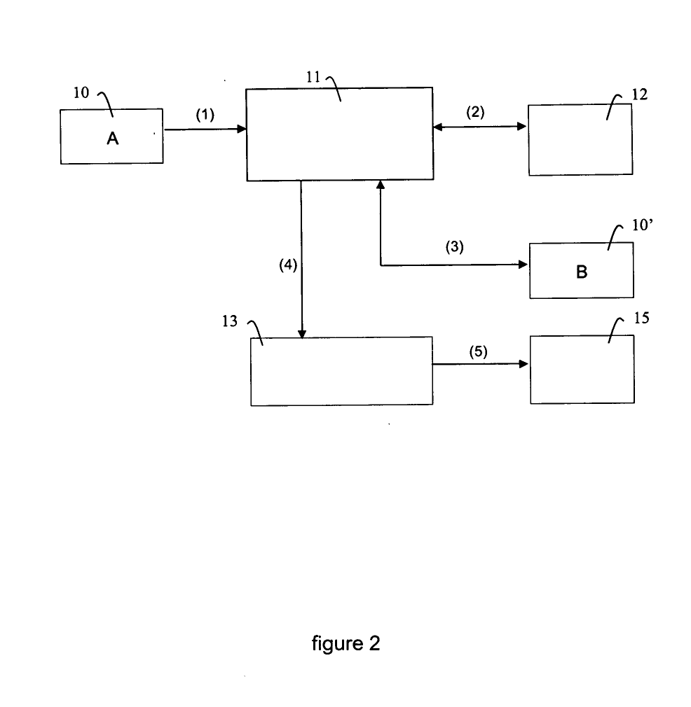

FIG. 2 represents the steps of a method according to the invention of processing the identity of a terminal user.

A system according to the invention for processing the identity of a terminal user therefore includes an identity processing server 11 and a service platform 13, 13′. Said identity processing server 11 is connected to one or more databases 12.

Said processing system, represented in FIG. 1, is used to manage the identity of a user of a first terminal 10 connected to a fixed or mobile telecommunications network. Managing the identity of the user of said first terminal 10 is much the same whether the connection of said terminal to said telecommunications network is fixed or mobile. The first terminal 10 is configured to send an identifier of the user of said terminal, which is of any kind, for example a mobile telephone, a personal computer (PC) or a fixed telephone using any generation technology. The first terminal 10 is denoted “A” in FIGS. 1 and 2.

The user of said first terminal 10 wishes to use a communications service 14, 14′, 14″, 14′″, for example one that consumes telephone call minutes or sends an SMS (Short Messaging Service) message, or any other communications service 14, 14′, 14″, 14′″. Said communications service 14, 14′, 14″, 14′″ may be situated in the same telecommunications network, a telecommunications network other than that of the first terminal 10, for example a fixed or mobile telephone network, or any communications network providing access to a communications service, such as the Internet.

At the time of access to said service, the first terminal 10 sends the identifier of the user who is to be recognized as the user of said communications service 14, 14′, 14″, 14′″. For example, for access to any communications service, if the first terminal 10 is a mobile telephone, the identifier may correspond to the MSISDN (Mobile Subscriber ISDN) of the user, while in the case of a personal computer (PC), the identifier may correspond to the electronic mail address of the user.

After said communications service has been consumed, the service provider sends a call report that is used to bill the service consumed by the user. Said system according to the invention for processing the identity of the user is used to enter in a call report an identity that need not correspond only and systematically to that of the actual user of said service. Said system for processing the identity of the user enables said identity parameter to be modified and chosen as part of the process of creating the call reports.

Said identity processing server 11 has the function of receiving and analyzing one or more identity parameters of the user of said first terminal 10. The identity processing server 11 may be situated in the same telecommunications network, a telecommunications network other than that of the first terminal 10, for example a fixed or mobile telephone network, or any other communications network, such as the Internet or a private communications network.

The identity processing server 11 includes a first communications interface 21 for exchanges of information between a rule management module 20 in said identity processing server 11 and said first terminals 10 consuming one or more communications services 14, 14′, 14″, 14′″.

Said first communications interface 21 also enables exchanges of information between the rule management module 20 and one or more second terminals 10′ contacted by said module 20 at the time of processing the identity of the user. At the time of processing the identity, the rule management module 20 may set up a connection to said second terminal 10′ in order to check said identity parameter. Said second terminal 10′ is also of any kind, for example a mobile telephone, a personal computer (PC) or a fixed telephone using the technology of any generation, denoted “B” in FIGS. 1 and 2.

The identity processing server 11 also includes one or more second communications interfaces 22 for exchanges of information between said rule management module 20 and one or more service platforms 13, 13′ that manage(s) said communications service 14, 14′, 14″, 14′″ consumed by the user.

Said communications interfaces 21 and 22 of the identity processing server 11 may be an application program interface (API), for example.

Said service platform 13, 13′ may be situated in the same telecommunications network, a telecommunications network other than that of the first terminal 10, for example a fixed or mobile telephone network, or any other communications network, such as the Internet or a private communications network.

Said service platform 13, 13′ includes a communications interface for dialogue with the identity processing server 11 and a module for receiving said processed identity parameter from said identity processing server 11. Said service platform 13, 13′ is adapted to manage one or more communications services.

The service platform 13, 13′ also includes a module for generating call reports following consumption of said communications service 14, 14′, 14″, 14′″. Said call reports are sent to a billing service, which debits subscriber accounts as a function of consumption, for example, or sends bills to subscribers.

Additionally, the identity processing server 11 is configured to receive one or more parameters corresponding to a communications service 14, 14′, 14″, 14″ from said first terminal 10 via the communications interface 21. Said parameter corresponding to the service 14, 14′, 14″, 14′″ may also be received from said service platform 13, 13′ that manages said communications service 14, 14′, 14″, 14′″ via the communications interface 22.

Said rule management module 20 has the function of looking up and processing one or more rules stored in one or more databases 12 connected to said rule management module 20, using said identity parameter of the user of the first terminal 10. Said database 12 may or may not be physically included in said processing system according to the invention.

Said rule may be linked to the identity of a user or to the use of a service. For example, a rule may specify that to use the service W with an identifier of the user A, the identity to be sent is the identifier of the user A, such that (service W, identifier A)=identity A. A second rule may specify that to use the service X with an identifier of the user A, the identity to be sent is the identifier of the user B, such that (service X, identifier A)=identity B. A further rule may specify that, regardless of the service used, for example after requesting authorization of the user B, on reception of the identifier of the user A, the identity to be sent is the identifier of the user B, such that (identifier A)=identity B. This is the case for a third party service where the service is billed to a specified third party, after obtaining the agreement of that third party.

Because of this, the identity of the user sent after processing by the identity processing server 11 and to be included in a call report in respect of a communications service 14, 14′, 14″, 14′″ may be different from that received at the time of access to said communications service 14, 14′, 14″, 14′″. In this way, the same user may be managed with a variety of identities, on the basis of identity management rules. More precisely, a plurality of subscriber identifiers may be associated with the same user identifier.

Said processed identity parameter may correspond to the identity of a user independent of said first terminal or said communications service.

In fact, processing the identity in order to enter a processed identity parameter in a call report after the consumption of a communications service enables the identity of a user to be defined for the purposes of billing the service that has been consumed. The identity of the user may be completely independent of said first terminal or said communications service. This system and this method therefore enable generalization of third party billing and entering an identity parameter corresponding to any subscriber, either one that is predefined or one that is entered manually by the user of the first terminal.

In the absence of a rule governing storage by the user or the operator, depending on the parameter values set, the database 12 of said identity processing system may, for example, contain a rule whereby the identity of the user included in the call report is automatically the same as that recognized by the telecommunications network or whereby, by default, authorization must be systematically and automatically requested from a user whose identity is predefined. Alternatively, in the absence of storage rules, the identity processing system may automatically request the user of said communications service 14, 14′, 14″, 14′″, at the time of access to said service, to enter manually an identifier corresponding to the identity of the user to be included in the call report.

The rule management module 20 is configured directly by users, by the operator of said telecommunications network or by the operator of the network that manages the identity processing server 11 or the operator of the network that manages the service platform 13, 13′. Depending on the configuration, the identity processing server 11 may be commanded only by said first terminal 10 to receive said identity parameter of the user of the first terminal 10. Depending on parameter values set by the operator or the user, it may also be automatically commanded to receive said identity parameter of the user of the first terminal 10 at the time of access to a communications service 14, 14′, 14″, 14′″.

Additionally, depending on the parameter values that have been set, said first terminal 10 may store one or more rules for managing the identity of the user of said first terminal 10 in a said database 12 beforehand, prior to access to a communications service 14, 14′, 14″, 14′″ by the first terminal 10.

In the same way, during its access to a communications service 14, 14′, 14″, 14′″, the first terminal 10 may store a rule for managing the identity of the user of said first terminal 10 in said database 12, if it has not done so beforehand, for a particular form of management different from the rules already stored, or in order to modify an existing rule. Said rule is then applicable dynamically to the current management of the identity of the user corresponding to said communications service 14, 14′, 14″, 14′″.

At present, consumption tickets for multimedia services, which are becoming more and more complex, necessitate processing and interpretation of the identity of the user of said service.

In fact, a user may have different identities for accessing one or more services and being billed for the service(s). For example, a user has a first identity corresponding to a “private user” profile and a second identity corresponding to a “business user” profile. The preferences of the user and the functions or options available may be different for each of these identities, for example a different charging scheme. Preferential access to certain services may be made available according to the profile, for example voice calls may be reserved for calls to a person from a private contacts list or access to the electronic mail service may be reserved for business use or for use of the multimedia messaging service (MMS), for example with different charges for a greater quantity of business messages, or finally the “private user” profile or the “business user” profile may be selected as a function of the time at which or the location from which the service is accessed.

Another example of this relates to members of the same family or members of a group with a common interest, where there is a subscription to a set of services. Those services may be used on a personal basis or as a family or group member. In this case, a “private user” identity is defined for which the service call report includes the identity parameter of the user and a “head of household” or “group manager” identity is defined for which the call report includes a single collective identity parameter, whichever member of the family or the group is using the service.

For the use of so-called “sensitive” services, for example services providing information of a pornographic nature or reserved for adults, the user may wish to dissociate a profile corresponding to the identity of the telephone subscriber from a profile for the consumer of said sensitive service. Firstly, in the case of the telephone subscriber, the billed item is shown on the user's home telephone bill. Secondly, the user may choose a rule for the consumption of a so-called sensitive service that provides a call report for said sensitive service using the identity corresponding to a pre-paid subscriber account, a more anonymous form of billing.

In a different situation, a user of a prepaid subscriber account, whose credit is used up, may continue to access a service if there is a rule that provides for a service call report with the identity of a specified third party. In this case, billing is transferred to the account of the specified user, indicated in said rule, in the same way as in the case of a third party service. It is actually the user whose credit is used up who uses said service, but this user wishes the account of another user to be debited. In particular, the third party service may be used if the user wishes to send an SMS message that is paid for by the recipient of said SMS message (or by any other subscriber).

According to the invention, a service call report may then be sent by a service platform 13, 13′ where the identity entered in the call report is not that of the actual user of said service. As a general rule, a call report may be linked to any pertinent identity in the context of the use concerned of the service (group identity, private identity, head of household identity, business identity, etc.).

In this way, the same user may be managed with a plurality of identities and a plurality of billing accounts, including billing a third party service. The identity of the user of the service is managed dynamically, as a function of rules stored, either beforehand or otherwise, and in particular as a function of the service consumed, the context, the time, the credit, etc. The rules that govern the use of a given service may be stored in advance or in use. The account to be debited according to a user identity included in a call report is not only that of the actual user of the service.

To assist in understanding the invention, the various steps of a method in accordance with the invention for processing the identity of a user of a terminal are represented in FIG. 2.

As described above, the user may first store one or more rules relating to managing and processing the identity of said user. Storing a rule beforehand is optional. The first terminal 10 may also store a rule at the time of using a communications service 14, 14′, 14″, 14′″. Said rule is then applicable dynamically during access by the first terminal 10 to said communications service 14, 14′, 14″, 14′″. Independently of rules stored (or not) by the user, the operator of the telecommunications network (or the operator of the identity processing server 11 or the service platform 13, 13′) may also store one or more predefined rules for managing the identity of the user of the terminal, for optimum management of the identity entered in a call report and consequently of billing a communications service 14, 14′, 14″, 14′″ which said user accesses.

The first terminal 10, denoted “A” in FIG. 2, is connected to the telecommunications network in order to access a communications service 14, 14′, 14″, 14′″.

The identity processing server 11 receives from said first terminal 10 an identity parameter of the user of said first terminal 10 and a parameter corresponding to said communications service 14, 14′, 14″, 14′″ (step 1).

Said identity and service parameters may come from said first terminal 10 (recognition of the user by the network or manual entry of the identifier) or from the service platform 13, 13′, for example.

The user of the first terminal 10 is recognized from the identity parameter that has been sent. The rule management module 20 is called at the time of access to said communications service 14, 14′, 14″, 14′″. It receives said identity and consumed service parameters.

Said rule management module 20 looks up one or more rules relating to said identity parameter it has received in a database 12 to which it is connected (step 2). Either said rule is stored by the user or the operator beforehand, or a rule may be stored dynamically at the time of access to the communications service 14, 14′, 14″, 14′″.

The rule management module 20 processes said rule corresponding to said identity parameter and recognizes the identity of the user to be included in said call report. The identity of the user may be managed as a function of the service consumed, the time of use, a private or business profile, a sensitive content (for example a content reserved for adults), etc. As mentioned above, the identity of the user sent after processing by the identity processing server 11 may (or may not) be different from that received at the time of access to said communications service 14, 14′, 14″, 14′″.

A rule may also specify that authorization be requested from the user whose identity is specified in said rule (step 3). At the time of processing said rule, the rule management module 20 then establishes a connection to one or more second terminals 10′ to check said identity parameter included in the rule. For example, said second terminal 10′, denoted “B” in FIG. 2, may be contacted by means of an SMS message or a voice call. The user of the second terminal 10′ must authorize the use of his or her own identity for the first terminal 10 in order to be able to access a communications service 14, 14′, 14″, 14′″.

For enhanced security, the identity processing system may optionally contact an existing unit adapted to receive and analyze an electronic signature from said second terminal 10′, which supplies the authorization, or from any other system capable of collecting or approving the identity of the user of the second terminal 10′, which supplies the authorization.

Once the rule has been processed and the verifications carried out, the identity processing server 11 sends said identity parameter processed as a function of said rule to one or more service platforms 13, 13′ which manage(s) the service concerned (step 4).

If necessary, on reception of said processed identity parameter, the service platform(s) 13, 13′ check(s) the balance of a subscriber account 15 corresponding to the identity sent by means of said processed identity parameter in order to authorize access by the first terminal 10 to said communications service 14, 14′, 14″, 14′″ (step 5). The communications service 14, 14′, 14″, 14′″ may then be used in the event of a positive result, in particular if the balance of said subscriber account shows sufficient credit.

Checking the balance of a subscriber account corresponding to the identity parameter is neither obligatory nor systematic. In the case of access to a post-paid communications service 14, 14′, 14″, 14′″, no balance of a subscriber account 15 is checked since the payment is effected independently of any subscriber account.

After access to said communications service 14, 14′, 14″, 14′″ by the first terminal 10, to enable billing of said service to the user identified by said identity parameter, the service platform 13, 13′ generates one or more call reports including said identity parameter and said parameter corresponding to the communications service 14, 14′, 14″, 14′″.

1. A method of processing the identity of at least one user of a first terminal (10) connected to a telecommunications network in order to access at least a communications service, wherein the method comprises the steps of:
at least an identity processing server receiving at least an identity parameter of the user of said first terminal and a parameter corresponding to said communications service;
at least a rule management module in said identity processing server using said identity parameter to look up at least a rule stored in at least a database connected to said rule management module;
said rule management module processing said rule;
said identity processing server sending at least a service platform said identity parameter processed as a function of said rule;
after consumption of said communications service by said first terminal, said service platform generating at least a call report including said parameter corresponding to said communications service and said processed identity parameter.

2. The processing method according to claim 1, wherein said identity processing server receives said identity and service parameters, separately or in combination, from said first terminal or from said service platform.

3. The processing method according to claim 1, wherein, before access by said first terminal to said communications service, said first terminal or the operator of the telecommunications network, separately or in combination, store in said database at least a rule for managing the identity of the user of said first terminal.

4. The processing method according to claim 1, wherein said first terminal commands said identity processing server to receive said identity parameter of the user of said first terminal.

5. The processing method according to claim 1, wherein said identity processing server is automatically commanded to receive said identity parameter of the user of said first terminal.

6. The processing method according to claim 1, wherein said first terminal stores in said database at least a rule for managing the identity of the user of said terminal applicable during access by said first terminal to said communications service.

7. The processing method according to claim 1, wherein, at the time of processing said rule, said rule management module establishes a connection with at least a second terminal for checking said identity parameter.

8. The processing method according to claim 1, wherein said processed identity parameter corresponds to the identity of a user who is independent of said first terminal or of said communications service.

9. The processing method according to claim 1, wherein said service platform checks the balance of at least a subscriber account corresponding to the identity sent by means of said processed identity parameter in order to authorize access by said first terminal to said communications service.

10. A system for processing the identity of at least one user of a first terminal connected to a telecommunications network in order to access at least a communications service, wherein said system comprises:
at least an identity processing server configured to receive from said first terminal at least an identity parameter of the user of said first terminal and a parameter corresponding to said communications service;
at least a rule management module in said identity processing server configured to look up and process at least a rule stored in at least a database connected to said rule management module; and
at least a service platform configured to receive from said identity processing server said parameter processed as a function of said rule and, after consumption of said communications service by said first terminal, to generate at least a call report including said parameter corresponding to said communications service and said processed identity parameter.

11. The processing system according to claim 10, wherein said first and second terminals are connected to said fixed or mobile telecommunications network in either a fixed manner or a mobile manner.

12. The identity processing server adapted to be used in a system according to claim 10, said server being configured to receive and send at least an identity parameter of the user of said first terminal and a parameter corresponding to a communications service, wherein said server is adapted to look up at least a rule stored in at least a database connected to at least a rule management module in said identity processing server in order to process said identity parameter as a function of said rule, said identity processing server including at least a first communications interface for transmission between said rule management module and said first and second terminals and at least a second communications interface for transmission between said rule management module and at least a service platform.

13. A rule management module adapted to be used in a system according to claim 10, wherein said module is included in said identity processing server in order to look up at least a rule stored in at least a database and to process at least an identity parameter of the user of said terminal as a function of said rule.

14. A rule management module according to claim 13, wherein said module establishes a connection with at least a second terminal in order to check said identity parameter at the time of processing said rule.

15. A service platform adapted to be used in a system according to claim 10, wherein said platform is configured to receive from said identity processing server at least an identity parameter of a user of a first terminal connected to a telecommunications network in order to access at least a communications service, said identity parameter being processed as a function of at least a rule, to check the balance of at least a subscriber account corresponding to the identity sent by said processed identity parameter, to authorize access by said first terminal to said communications service and, after access to said communications service by said first terminal, to generate at least a call report including said parameter corresponding to said communications service and said processed identity parameter.
